(19) United States
(12) Patent Application Publication
(10) Pub. No.: US 2022/0340774 A1
(43) Pub. Date: Oct. 27, 2022

(54) COATING COMPOSITION, COATED ASSEMBLY AND METHOD OF SEALING THE SURFACE OF A FIBROUS WEB

(71) Applicant: 3M INNOVATIVE PROPERTIES COMPANY, St. Paul, MN (US)

(72) Inventors: Chunjie Zhang, Shoreview, MN (US); Pingfan Wu, Woodbury, MN (US); Tianying Jiang, Inver Grove Heights, MN (US); Liang Gong, Woodbury, MN (US)

(21) Appl. No.: 17/640,929

(22) PCT Filed: Aug. 19, 2020
(86) PCT No.: PCT/IB2020/057810

§ 371 Date: Mar. 7, 2022

Related U.S. Application Data
(60) Provisional application No. 62/903,322, filed on Sep. 20, 2019.

(51) Int. Cl. C09D 127/16; C09D 127/18; C09D 127/20; C08K 3/34; D06M 15/256; C09D 7/61; D06M 11/77; D06M 15/31

(52) U.S. Cl. CPC C09D 127/16; C09D 127/18; C09D 127/20; C08K 3/34; D06M 15/256; C09D 7/61; D06M 11/77; D06M 15/31

(57) ABSTRACT

The present disclosure provides a high temperature, flame resistant and flexible coating composition based on alkali silicate and fluoropolymers. The coating can be used to bond a surface of a non-woven mat and seal the edges. The coating composition can be applied using a coating method on the surface and the edges of, for example, an inorganic fiber based non-woven mat.

### TECHNICAL FIELD

The present invention relates to a coating composition, a coated assembly, and a method of sealing a surface of a fibrous web.

### BACKGROUND

Cured polymers such as crosslinked polycarbonates and polyelastomers are widely known to be used as seals, gaskets, and molded parts in systems that are exposed to elevated temperatures and/or corrosive materials. Such parts are used in applications such as automotive, chemical processing, semiconductor, aerospace, and petroleum industries, medical devices, industrial tools, electronics, among others.

### SUMMARY

The present invention relates to a coating composition and a method of sealing a surface of a fibrous web. The present invention also relates to a coated assembly having applicability in various fields such as automotive, chemical processing, medical, semiconductor, electronics aerospace, petroleum industries, among others.

In one embodiment of the present disclosure, a coated assembly that includes a substrate, and a coating disposed on the substrate is disclosed. The coating is composed of a fluoropolymer and a crosslinked alkali silicate dispersed in the fluoropolymer. The weight ratio of fluoropolymer to crosslinked alkali silicate is from 1:1 to 10:1.

In some embodiments, the coated assembly includes a thermoplastic fluoropolymer.

In some embodiments, the thermoplastic fluoropolymer includes a copolymer of tetrafluoroethylene, hexafluoropropylene, and vinylidene fluoride.

In another embodiments, a coated assembly is disclosed. The coated assembly includes a substrate and a coating disposed on the substrate. In some embodiments, the coating includes a thermoplastic fluoropolymer and crosslinked alkali silicate dispersed therein.

In some embodiments, the thermoplastic fluoropolymer in the coating assembly includes a copolymer of tetrafluoroethylene, hexafluoropropylene, and vinylidene fluoride.

In some embodiments, the alkali silicate includes sodium silicate.

In some other embodiments, the substrate includes a fibrous web.

In some embodiments, the fibrous web may include non-meltable fibers.

In some embodiments, the non-meltable fibers include oxidized polyacrylonitrile.

In some embodiments, the fibrous web includes ceramic fibers.

In some embodiments, the ceramic fibers include polycrystalline aluminosilicate fibers.

In some embodiments, the coated assembly includes a monolithic coating.

In some embodiments, the coated assembly passes the UL-94V0 flame test.

In yet another embodiment, a coating composition is disclosed therein. The coating composition includes a fluoropolymer emulsion and an alkali silicate solution. The weight ratio of fluoropolymer solids to crosslinked alkali silicate solids is from 1:1 to 10:1.

In some embodiments, the alkali silicate in the coating composition includes sodium silicate.

In some embodiments, the fluoropolymer emulsion in the coating composition includes a copolymer of tetrafluoroethylene, hexafluoropropylene, and vinylidene fluoride.

In another embodiment, a method of sealing a surface of a fibrous web is disclosed. The method includes applying onto the surface a mixture that includes a fluoropolymer emulsion and alkali silicate dispersed in water, and removing the water from the mixture to crosslink the alkali silicate to seal the surface.

In some embodiments, the water is removed by heating the mixture to a temperature of above 140° C.

In some embodiments, the fibrous web includes oxidized polyacrylonitrile.

In some embodiments, the fibrous web includes ceramics fibers.

In some embodiments, the ceramics fibers include polycrystalline aluminosilicate fibers.

### BRIEF DESCRIPTION OF THE DRAWINGS

Exemplary embodiments disclosed herein may be more completely understood in consideration of the following detailed description in connection with the following figures. The figures are not necessarily drawn to scale. Like numerals used in the figures refer to like components. When pluralities of similar elements are present, a single reference numeral may be assigned to each plurality of similar elements with a small letter designation referring to specific elements. When referring to the elements collectively or to a non-specific one or more of the elements, the small letter designation may be eliminated. However, it will be understood that the use of a numeral to refer to a component in a given figure is not intended to limit the component in another figure labeled with the same number.

FIG. 1 is a cross-sectional view of a coated assembly according to a first embodiment of the present invention;

FIG. 2 depicts a method of sealing the edges and two surfaces of a substrate with the coating; and

FIG. 3 depicts a method of sealing the substrate with a coating on the edges and a scrim on two surfaces.

### DETAILED DESCRIPTION

In the following description, reference is made to the accompanying figures that form a part thereof and in which various embodiments are shown by way of illustrations. It is to be understood that other embodiments are contemplated and may be made without departing from the scope or spirit of the present disclosure. The following detailed description, therefore, is not to be taken in a limiting sense.

Moreover, the terms top, bottom and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof.

Similarly, it should be appreciated that in the description of exemplary embodiments of the invention, various features of the invention are sometimes grouped together in a single embodiment, figures, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Provided is a coating composition that includes an alkali silicate and a fluoropolymer emulsion. The coating composition of the present disclosure is disposed on a surface of a fibrous web to seal the edges, thereby reducing fiber shedding while preserving flexibility. The present invention is further related to a method of coating. The method includes applying onto a surface a coating composition that includes a mixture of fluoropolymer emulsion and alkali silicate dispersed in water. The method further includes removing of water from the mixture to crosslink the alkali silicate and seal the surface.

In some embodiments, the alkali silicate is sodium silicate. Sodium silicate, also known as water glass, is an inorganic compound that contains an anionic polymeric chain composed of tetrahedral SiO₄ units.

The drying and curing process of a sodium silicate aqueous solution involves a condensation polymerization that combines two silanol groups generated by hydrolysis and releases one water molecule. Sodium silicate has a wide spectrum of applications, including cement for making paper board, water treatment, passive fire protection and automotive repairing. In particular, it has high temperature performance and is both flame resistant and intumescent. However, the use of sodium silicate to coat flexible substrates is limited because of its brittle nature. As the cured sodium silicate coating is highly crosslinked and has a rigid backbone, broken pieces may fall off the substrate when the coated article is bended or flexed.

Fluoropolymers can be used for a wide variety of industrial applications. Fluoropolymers generally exhibit a property of high thermal stability. An example of a fluoropolymer is the copolymer of tetrafluoroethylene, hexafluoropropylene and vinylidene fluoride (THV). THV can have a melting point of up to 200 degrees Celsius (° C.) and show excellent permeation barrier properties.

THV emulsion can be used as a coating on various substrates. Generally, a THV emulsion is cast onto the substrate, followed by drying and melting at 140° C., to generate a flexible and mechanically robust coating. THV also has high temperature performance and is flame resistant.

The present invention relates to a coating composition that is composed of fluoropolymer emulsion and alkali silicate dispersion that crosslinks together to form a uniform coating on a desired substrate, thereby providing a cost-effective, flexible, flame resistant coating that can remain integral after being flexed. In some cases, the coating bonds with other materials as well, especially adhesives.

Generally, the present invention incorporates a thermoplastic fluoropolymer. Suitable fluoropolymers include, for example, those that are prepared (for example, by free radical polymerization) from monomers including chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (for example, a perfluoro (alkoxyvinyl ether) such as CF₃OCF₂CF₂OCF═CF₂, or a perfluoro (alkyl vinyl ether) such as perfluoro (methyl vinyl ether) or perfluoro (propyl vinyl ether)), cure site monomers such as nitrile-containing monomers (for example, CF₂═CFO(CF)_{L}CN, CF₂═CFO[CF₂CF(CF₃)O]_{q}(CF₂O)yCF(CF₃)CN, CF₂═CF[OCF₂CF(CF₃)]ᵣO(CF₂)ₜCN, or CF₂═CFO(CF₂)ᵤOCF(CF₃)CN, wherein L=2-12; q=0-4; r=1-2; y 0-6; t=1-4; and u=2-6), bromine containing monomers (ZRf-Ox-CF═CF₂, wherein Z is Br or I, R f is a substituted or unsubstituted C₁-C₁₂ fluoroalkylene, which may be perfluorinated and may contain one or more ether oxygen atoms and x is 0 or 1 is); or a combination thereof, optionally, in combination with additional non-fluorinated monomers such as ethylene or propylene.

In some cases, fluoropolymers include copolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro (alkyl vinyl ether) copolymers (for example, tetrafluoroethylene-perfluoro (propyl vinyl ether)); and combinations thereof.

In some cases, commercially available thermoplastic fluoropolymers include for example, those marketed by Dyneon LLC, Oakdale, Minn., under the trade name “THV” (for example, “THV 220”, “THV 340Z” “THV 400G”, “THV 500G”, “THV 815” and “THV 610X”).

In some embodiments, the fluorine content of THV is in the range of 60-76 weight percent (wt. %). In some cases, the fluorine content of fluoropolymer is typically at least 60, 65, 66, 67, 68, 69, or 70 wt % of the fluoropolymer and typically no greater than 77 wt %.

In some embodiment, the fluoropolymers used in the present invention are in the form of a dry powder having an average particle size of from 1 micrometer (μm) up to about 500 μm. In some cases, the fluoropolymers are made by aqueous dispersion polymerization, wherein the fluoropolymer particles having a particle size in the range of 0.05 to 0.5 μm in diameter. The particle sizes disclosed herein are volume average particle sizes. The aqueous dispersions of fluoropolymers can be used to provide the water and fluoropolymer components of the emulsions of the present invention.

In some embodiments, the emulsions of the present invention can contain only the submicron size fluoropolymers, in which case the fluoropolymer can constitute generally 10 wt %, preferably 70 wt % in an aqueous dispersion of the emulsion, and preferably 50 wt % of the emulsion. Preferably, the emulsion contains fluoropolymer particles with bimodal size distribution, e.g. 25 wt % of the 200 nanometer (nm) size particles and together with 25 wt. % of the 120 nm size particles. In some embodiments, the emulsion of the present invention has a basic pH. In some cases, the emulsion has a pH ranging from 7-12.

In some embodiments, the emulsions of the present invention are made by blending an emulsifying agent (such as oil) into the water phase containing the fluoropolymer particles under conditions of high shear to distribute the emulsifying agent into the water phase in the form of fine droplets. Examples of emulsifying agents include non-ionic surfactants and anionic surfactants.

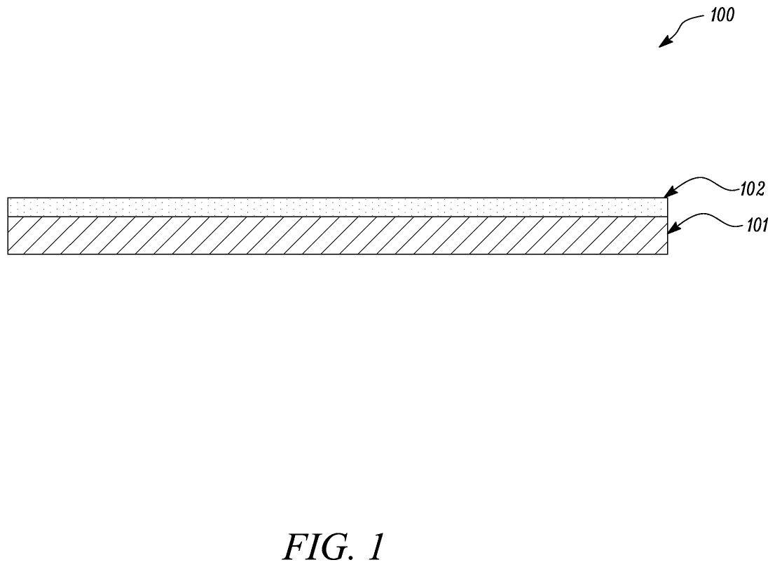

Furthermore, the present invention is directed to a coated assembly that includes a substrate and a coating composition disposed on the substrate. As shown in FIG. 1, the coated assembly 100 includes a substrate 101, upon which a coating composition 102 is disposed. In some cases, the coating composition 102 is dried and cured.

In some cases, the coating composition can be applied to any number of substrates which can withstand bake temperatures of at least 120° C. In particular, the coating compositions can be applied to substrates such as fibrous, non-fibrous, or porous substrates. Examples of substrates include metals, ceramics, poly acrylonitrile films, polyethylene therephthalate (PET), aluminum, anodized aluminum, cold-rolled steel, stainless steel, enamel, glass, and pyroceram. More preferably, the substrate can be polyacrylonitrile films such as oxidized polyacrylonitrile (OPAN) films. In some embodiments, the non-fibrous substrates can be selected from polyethylene terephthalate (PET) or polycarbonates. In some embodiments, porous layers include, but are not limited to, non-woven fibrous layers, perforated films, particulate beds, open-celled foams, fiberglass, nets, woven fabrics, and combinations thereof.

In some embodiments, the coating composition can be applied to non-woven mats that include inorganic fibers. In some embodiments, the inorganic fibers can be ceramic fibers. In some embodiments, the coating composition can be applied to ceramic-based non-woven mats. These ceramic-based non-woven mats include ceramic fibers.

In some embodiments, the ceramic fibers can be combined with alkaline earth silicate (AES) low biopersistent fibers, aluminosilicate ceramic fibers (RCF), and/or alumina silica fibers and vermiculite with an acrylic latex and other refractory materials to obtain a heat-resistant non-woven fibrous web, or mat. In some embodiments, the ceramic fiber includes polycrystalline aluminosilicate fibers.

In some embodiments, the ceramic based non-woven mat can be a polycrystalline aluminosilicate mat. In some cases, these fiber materials are blended with flame-retardant additives such as aluminum trihydrate (ATH). These materials are optionally intumescent, whereby the material swells up when heated to seal openings in the event of a fire. Examples of these ceramic fiber materials include products provided under the trade designation FYREWRAP by Unifrax I LLC, Tonawanda, N.Y.

In some embodiments, the polycrystalline aluminosilicate mat includes polycrystalline α-alumina-based fibers. In some cases, these polycrystalline α-alumina-based fibers can have melting temperatures well in excess of 1400° C. The non-combustible fibers can have a melting temperature in the range from 700° C. to 2000° C., from 800° C. to 2000° C., from 1100° C. to 1700° C. In some embodiments, less than, equal to, or greater than 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., 1600° C., 1650° C., 1700° C., 1750° C., 1800° C., 1850° C., 1900° C., 1950° C., or 2000° C.

Alternatively, the ceramic fibers include ceramic oxide fibers that can be processed into fire-resistant fabrics. Commercial examples of these fibers include filament products provided under the trade designation NEXTEL by 3M Company, St. Paul, Minn. These fibers can be converted into woven fibrous webs that display both fire barrier properties and high strength. In some aspects, these materials can be made suitable for textiles by mixing small amounts of silica, boron oxides, or zirconium oxides into alumina to avoid formation of large crystalline grains, thereby reducing stiffness and increasing strength at ambient temperatures.

In some embodiments, the coating composition of the present disclosure can be applied to a wide variety of substrates to form thick crack-free coatings by conventional means. Spray coating, meyer rod coating, and roller coating are the most convenient application methods, depending on the substrate being coated. Other well-known coating methods including dipping and coil coating are suitable. In some cases, the coating emulsion compositions may be applied as a single coat or as a multiple number of coats. In some cases, the emulsion can further be diluted with water just prior to spraying to a suitable viscosity for achieving a crack-free coating of a desired thickness. The dried film thickness, DFT, of a single coat can be at least 0.1 μm, preferably at least 0.5 μm, and more preferably at least about 1.0 μm. In some embodiments, the maximum crack-free single pass coating thickness can be 5.0 μm. With the coating composition, it is possible to apply several coating layers to reach thicknesses of greater than 10 μm, preferably greater than 20 μm.

In some embodiments, the weight ratio of the fluoropolymer to crosslinked alkali silicate is from 1:1 to 10:1, preferably 4:1. In some embodiments, alkali silicate includes sodium silicate. Alternatively, alkali silicate may include lithium silicate, magnesium silicate, potassium silicate, or calcium silicate. The alkali silicate raw material is provided as a liquid solution or dispersion. In some embodiments, the alkali silicate is prepared by dissolving at least 10 g of alkali silicate in 100 mL of water to obtain an aqueous solution.

In some cases, the coating composition can include additional components such as surfactants. More particularly, surfactants can include an amphoteric surfactant, for example, Amphosol CA, DEHYTON® PK 45, and DEHYTON® AB 30. These surfactants act as foam boosters and viscosity builders. In some aspects, these surfactants modify the surface energy of the coating formulations to improve the wetting and penetration into the substrate.

Further, the present disclosure is directed to a method of sealing a surface of a fibrous web with a coating composition. The method includes applying the coating composition that includes a fluoropolymer emulsion and alkali silicate dispersed in water onto a surface; and removing the water from the coating composition to crosslink the alkali silicate and seal the surface. In some cases, the crosslinked alkali silicate is formed through condensation of silicate anions which releases water molecules and generates Si—O—Si linkage. In some cases, the crosslinked alkali silicate has various molecular weights and a branched molecular structure.

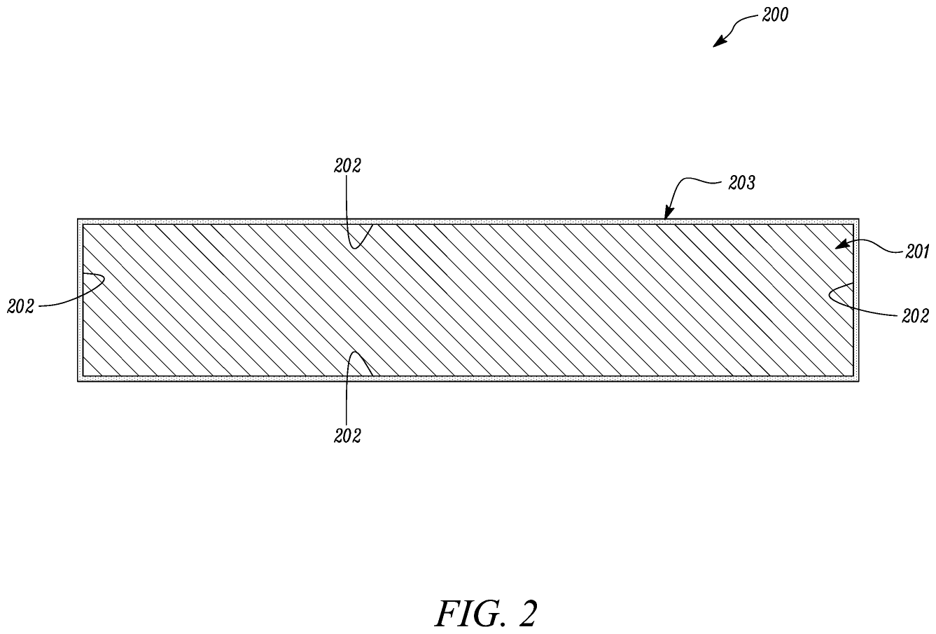

FIG. 2 depicts a method of sealing the substrates with the coating composition according to another embodiment. As depicted in FIG. 2, a coated assembly 200 is formed by coating a top surface, a bottom surface, and an edge (collectively indicated as surface 202) of a non-woven mat 201 with the coating composition to form a densified layer 203.

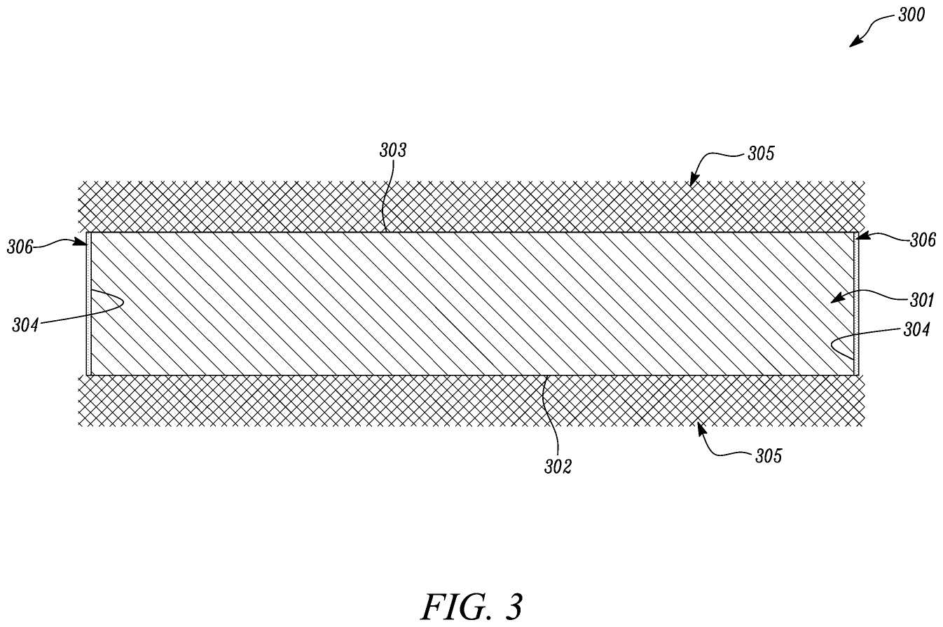

According to another embodiment, in FIG. 3, a coated assembly 300 for sealing a surface of a fibrous web is provided. Specifically, the coated assembly 300 is formed by sealing a surface of the fibrous web with the coating composition. The assembly 300 includes lamination of a top surface 303 and a bottom surface 302 of a non-woven mat 301 with scrims 305 to form a sandwich construction followed by application of coating 306 to seal the edges 304, as shown in FIG. 3. In both approaches, the loftiness of the non-woven mat 301 may be preserved, and fiber shedding of the non-woven mat 301 may be reduced.

In some embodiments, a method of sealing a surface of a fibrous web is provided. The method includes providing the fibrous web 201 having the surface 202. The method includes applying onto the surface a mixture. The mixture includes a fluoropolymer emulsion and alkali silicate dispersed in water.

In some embodiments, the fluoropolymer includes a thermoplastic fluoropolymer. In some embodiments, the fluoropolymer includes copolymer of tetrafluoroethylene, hexafluoropropylene and vinylidene fluoride. Alternatively, various fluoropolymers are suitable according to this embodiment of the present disclosure. Other types of fluoropolymers have been discussed above.

In some embodiments, the alkali silicate may include lithium silicate, potassium silicate, calcium silicate, or magnesium silicate.

In some embodiments, the weight ratio of the fluoropolymer to crosslinked alkali silicate can be in the range of from 1:1 to 10:1. More particularly, the weight ratio of the fluoropolymer to crosslinked alkali silicate can be 2:1 to 6:1.

In some cases, the fibrous web includes oxidized polyacrylonitrile. More generally, the method can be applied to any of fibrous, non-fibrous, or porous substrates. In some embodiments, the non-fibrous substrates may be selected from films of polyethylene terephthalate (PET) and polycarbonates. In some embodiments, porous layers include, but are not limited to, non-woven fibrous layers, perforated films, particulate beds, open-celled foams, fiberglass, nets, woven fabrics, and combinations thereof.

In some embodiments, the fibrous web includes ceramics based non-woven mats. In some aspects, the ceramic based non-woven mat can be polycrystalline aluminosilicate non-woven mat.

The method further includes a step of removing the water from the mixture to crosslink the alkali silicate and seal the surface. In some cases, the water is removed by heating the mixture to a temperature of above 140° C. In some embodiments, the heating of the mixture is achieved at a temperature range from 100° C. to 250° C.

The present disclosure is further illustrated by the following examples, but the particular materials and amounts thereof recited in these examples, as well as other conditions and details, should not be construed to unduly limit this disclosure.

### EXAMPLES

Unless otherwise noted, all parts, percentages, ratios, etc., in the examples and in the remainder of the specification are by weight. The following is a list of materials used throughout the Examples, as well as their brief descriptions and origins.

The materials used to prepare the coating composition are listed in Table 1 below.

TABLE 1
Details of materials

| Material | Description | Source |
|---|---|---|
| Sodium | Approximately 41° Baume in aqueous | Avantor, |
| silicate | solution, J. T. Baker, Specific Gravity | Radnor, PA., |
| | at 25°/25° C., 1.35-1.42, from | United States |
| THV | 3M ™ Dyneon ™ Fluoroplastic THV | 3M Company, St. |
| dispersion | 340Z, solid content of about 50 wt. % | Paul, MN., |
| | | United States |
| Amphosol | Amphoteric surfactant, 30 wt % active | Stepan Company, |
| CA | ingredients, | Northfield, IL. |
| | | United States) |
| OPAN | The web is mainly made by two materials: | Zoltek OX, |
| non- | (1) OPAN fiber: Zoltek OX staple fibers at | Bridgeton, MO |
| woven | 1.7 dTex and 50 mm in length. (2) FR | and Trevira |
| mat | PET binder fiber: Trevira T276, PET with | GmbH, |
| | organophosphate additives for flame | Bobingen, |
| | resistance. The melting temperature is | Germany |
| | around 240° C. | |
| PolyX | Polycrystalline aluminosilicate | 3M Company, St. |
| Non- | inorganically bonded nonwoven mat, 279 | Paul, MN. |
| woven | gsm | United States). |
| Mat 1 | | PolyX non-woven |
| | | mat includes |
| | | PolyX fibers are |
| | | polycrystalline |
| | | alumina fibers |
| | | from Mitsubishi |
| | | Chemical |
| | | Corporation under |
| | | trade name |
| | | MAFTEC. |
| PolyX | Polycrystalline aluminosilicate non-woven | (3M Company St. |
| Non- | mat filled with alumina trihydrate (ATH), | Paul, MN. |
| woven | 967 gsm (3M Company). | United States |
| Mat 2 | | |

Preparation of Non-Woven Mats

### Preparatory Example 1.1: Preparation of Oxidized Polyacrylonitrile Non-Woven Mat

Oxidized polyacrylonitrile (OPAN) and T276 were blended together to produce a web. The weight blending ratio of OPAN and T276 was 9:1. The basis weight was 130 gsm. The web was folded upon itself (changing basis weight to 260 gsm) and was then conveyed to a Dilo Needle Loom, Model DI-Loom OD-1 6 from Eberbach, Germany having a needle board array of 23 rows of 75 needles/row where the rows are slightly offset to randomize the pattern. The needles were Foster 20 3-22-1.5B needles. The array was roughly 17.8 cm (7 inches) deep in the machine direction and nominally 61 cm (24 inches) wide with needle spacings of roughly 7.6-mm (0.30 inch). The needle board was operated at 91 strokes/minute to entangle and compact the web to a roughly 5.1-mm (0.20 inch) thickness.

### Preparatory Example 1.2: Preparation of Polycrystalline Aluminosilicate Non-Woven Mat (PolyX Non-Woven Mat 1)

A fibrous polycrystalline oxide non-woven mat (PolyX non-woven Mat 1) made from substantially continuous fibers was assembled and needled by processes and techniques described in Sol Making Method 2 and Fiber Spinning Method 1 of commonly owned PCT Application Number 2018/093624 published on May 24, 2018, which is incorporated herein by reference. More specifically, green fiber webs were mechanically entangled using a needle-tacker from Feltloom of Sharpsburg, Ky. loaded with needles type 15×18×32×3½ U333 from Groz-beckert USA, Inc. from Fort Mill of South Carolina. After one pass through the needled-tacker, each sample was run again through the equipment after turning the sample over. Final punching density was calculated around 25 punch/cm². Next, needled green fiber webs were fired and sintered into a ceramic mat with a sintering temperature between 1285° C. and 1300° C.

### Preparatory Example 1.3: Preparation of Polycrystalline Aluminosilicate Non-Woven Mat (PolyX Non-Woven Mat 2)

A fibrous polycrystalline oxide non-woven mat (PolyX non-woven Mat 2) made from substantially continuous fibers was assembled by processes and techniques described in Sol Making Method 2 and Fiber Spinning Method 1 of commonly owned PCT Application No. WO 2018/093624 published on May 24, 2018, which is incorporated herein by reference. However, rather than using the needling technique to bind the mat, a silicone lubricant wet inorganic binder was coated onto the mat as the fibers accumulated on the porous collector. The fibers were then fired and sintered into a ceramic mat with a sintering temperature between 1285° C. and 1300° C.

Preparation of OPAN Based Coated Assembly Using Sodium Silicate-Based Coating Composition

### Comparative Example 2.1

The OPAN mat (e.g., non-woven mats 200 and 300) has the ABA sandwich structure. The middle layer (layer B) is 90% OPAN and 10% PET. The top and bottom layer (layer A) are 70% OPAN and 30% PET. Various formulations of coating compositions according to an exemplary embodiment were prepared and are tabulated in Table 2.

TABLE 2
Coating Compositions

| | Sodium | | | | |
|---|---|---|---|---|---|
| | silicate | Amphosol | | Solids | Amphosol |
| | (g, 46 | CA (g, 30 | | % in | CA % in |
| | wt % in | wt % in | Water | Coating | Total |
| Formulation | water) | water) | (g) | Formulation | Solids |
| CE2.1A | 1.0 | 0.02 | 9.0 | 4.7 | 1.3 |
| CE2.1B | 2.0 | 0.04 | 8.0 | 9.3 | 1.3 |
| CE2.1C | 3.0 | 0.06 | 7.0 | 13.9 | 1.3 |
| CE2.1D | 4.0 | 0.08 | 6.0 | 18.5 | 1.3 |

The formulations CE 2.1A-CE 2.1 D were applied on the four edges of a ABA non-woven mat (4 inch×6 inch) using a brush followed by drying in an oven at 90° C. for 10 min. Further, atomizer was used to spray this formulation onto OPAN non-woven mat (e.g., non-woven mats 200 and 300, 4 inch×6 inch, 90% OPAN and 10% PET) followed by drying at 140° C. for 10 min in an oven. The process was repeated on the other surface. Edge sealing was performed by dipping the edges of the coated article in the same formulation followed by drying in an oven at 140° C. for 10 min.

### Example 2.2

Formulation E2.2A-D were made by mixing THV solution and sodium silicate solution according to Table 3.

TABLE 3
Coating Compositions

| | | | 5 wt % | 10 wt % | 20 wt % | Solids % | THV/ | |
|---|---|---|---|---|---|---|---|---|
| | 20 wt % | 10 wt % | Sodium | Sodium | Sodium | in coating | Sodium | |
| Formula | THV | THV | silicate | silicate | silicate | formulation | silicate | pH |
| E2.2A | 2.0 | 0.0 | 2.0 | 0.0 | 0.0 | 12.5 | 4:1 | 11 |
| E2.2B | 2.0 | 0.0 | 0.0 | 2.0 | 0.0 | 15.0 | 2:1 | 12 |
| E2.2C | 2.0 | 0.0 | 0.0 | 0.0 | 2.0 | 20.0 | 1:1 | 12 |
| E2.2D | 0.0 | 2.0 | 0.0 | 2.0 | 0.0 | 10.0 | 1:1 | 12 |

1 mL of the mixture was dropped onto the surface of the non-woven mats and spread across the surface using a glass slide. The coated samples were dried in an oven at 140° C. for 10 min.

### Example 2.3

Formulations E2.3A-E2.3C were made by mixing THV solution and sodium silicate solution according to Table 4.

TABLE 4
Coating Compositions

| | | Sodium | Sodium | Sodium | | | |
|---|---|---|---|---|---|---|---|
| | THV | silicate | silicate | silicate | Solids % | THV/ | |
| | (g, 20 | (g, 2.5 | (g, 5 | (g, 10 | in coating | Sodium | |
| Formulation | wt %) | wt %) | wt %) | wt %) | formulation | silicate | pH |
| E2.3A | 2.0 | 2.0 | 0.0 | 0.0 | 12.5 | 8:1 | 11 |
| E2.3B | 2.0 | 0.0 | 2.0 | 0.0 | 12.5 | 4:1 | 11 |
| E2.3C | 2.0 | 0.0 | 0.0 | 2.0 | 15.0 | 2:1 | 12 |

The formulations were sprayed onto the lofty non-woven (15 gsm, made through the carding process) and then pressed with a meyer rod to remove the excess of liquid. The coated sample was dried in an oven at 140° C. for 10 min. The dried article was used as scrim to make the ABA construction as depicted in FIG. 3.

Quantification of Fiber and Debris Shedding

### Examples E3A-E

Optical Particle Counting (OPC) (AccuSizer SIS, SW780 Software, Summation Sensor with a minimum of 0.50 μm) was applied to measure the fiber and debris shedding from the coated non-woven samples. A pristine OPAN non-woven sample was used as control. The coating formulations are summarized in Table 5.

TABLE 5
Coating Composition

| | | Sodium | Sodium | Sodium | Sodium | | | | |
|---|---|---|---|---|---|---|---|---|---|
| | THV | silicate | silicate | silicate | silicate | | Solids % | THV/ | |
| | (g, 20 | (g, 2.5 | (g, 5 | (g, 10 | (g, 20 | Water | in coating | Sodium | |
| Formulation | wt %) | wt %) | wt %) | wt %) | wt %) | (g) | formulation | silicate | pH |
| E3A | 2.0 | 2.0 | 0.0 | 0.0 | 0.0 | 0.0 | 11.3 | 8:1 | 11 |
| E3B | 2.0 | 0.0 | 2.0 | 0.0 | 0.0 | 0.4 | 11.4 | 4:1 | 11 |
| E3C | 2.0 | 0.0 | 0.0 | 2.0 | 0.0 | 1.3 | 11.3 | 2:1 | 12 |
| E3D | 2.0 | 0.0 | 0.0 | 0.0 | 2.0 | 3.1 | 11.3 | 1:1 | 12 |
| E3E | 2.0 | 0.0 | 0.0 | 0.0 | 0.0 | 1.5 | 11.4 | NA | 11 |

The non-woven samples (˜2 inch×2 inch) were dip coated in the formulations and then squeezed to remove the excess of liquid followed by drying in an oven at 140° C. for 10 min to provide Examples E3A-E as shown in Table 5. The dried samples were immersed in 15 mL of deionized water and mixed on a vortex mixer at 1500 rpm for 30 seconds. The water samples were analyzed by optical particle counting to quantify the fiber and debris shedding in the size range 0.5-500 μm. Results are summarized in Table 6 as compared to background (deionized water).

TABLE 6
Optical Particle Counting

| | Total Counts | Mean/ | Mode/ | Median/ |
|---|---|---|---|---|
| Sample | (15 mL original) | μm | μm | μm |
| Uncoated | 1.27E+07 | 1.24 | 0.54 | 0.7 |
| E3A | 6.05E+04 | 1.12 | 0.57 | 0.67 |
| E3B | 1.58E+05 | 0.98 | 0.51 | 0.67 |
| E3C | 3.75E+05 | 0.93 | 0.6 | 0.67 |
| E3D | 5.84E+05 | 0.9 | 0.6 | 0.67 |
| E3E | 2.67E+05 | 0.88 | 0.51 | 0.64 |
| Deionized | 5.17E+02 | 1.14 | 0.64 | 0.67 |
| water | | | | |

Note:
Mean/μm is the sum of the particle diameter of the particles divided by number of particles.
Meadian/μm is the value in which 50% of particles (by number) have size below a threshold value.
Mode/μm is a value in which most of the particles (by number) are detected at this diameter.

Preparation of PolyX Based Coated Assembly Using Sodium Silicate-Based Coating Composition

### Example 4.1

PolyX non-woven mat 1 obtained from Example 1.2, was coated with deep coat formulation E2.2D (on Table 3). The formulation was then dry and cured in a 150° C. in oven for 30 minutes in order to cure the coating composition completely. Post curing, the mat basis weight increased by 50 gsm.

### Example 4.2

Further, PolyX non-woven mat 2 obtained from Example 1.3 was coated with deep coat formulation E2.2D (on Table 3). The formulation was then dry and cured in a 150° C. oven for 30 minutes in order to cure the coating composition completely. It has been observed that, after curing, the mat basis weight increased only by 20 gsm. Without wishing to be bound by theory, it is believed that the water inside the ATH came out.

Determination of Flame Resistance of the Coated Assembly

UL-94V0 is a standard for safety for flammability of plastic materials. The coated assembly obtained from Example E2.2A-D were tested for flame resistance using the following procedure.

A methane flame that is 20 mm high is applied twice for 10 seconds each. If the sample:

(1) flame self-extinguishes in less than 10 seconds after each application;

(2) does not drip and ignite the cotton underneath;

(3) does not burn to the top (the 5″ (125 mm) mark));

If the test material exhibits the above describes parameters, it passes the UL-94V0 flame test.

The coated assembly obtained from Example E2.3A-D were tested for flame resistance using UL-94V0 flame test protocol. The coated substrates of the present invention pass the UL-94V0 flame test.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

While the invention has been described in connection with certain embodiments, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. (canceled)

2. (canceled)

3. (canceled)

4. A coated assembly comprising:
a substrate comprising a fibrous web; and
a coating disposed on the substrate, the coating comprised of a thermoplastic fluoropolymer and crosslinked alkali silicate dispersed therein.

5. The coated assembly of claim 4, wherein the thermoplastic fluoropolymer comprises a copolymer of tetrafluoroethylene, hexafluoropropylene, and vinylidene fluoride.

6. The coated assembly of claim 4, wherein the alkali silicate comprises sodium silicate.

7. (canceled)

8. The coated assembly of claim 4, wherein the fibrous web comprises non-meltable fibers.

9. The coated assembly of claim 8, wherein the non-meltable fibers comprise oxidized polyacrylonitrile.

10. The coated assembly of claim 4, wherein the fibrous web comprises ceramic fibers.

11. The coated assembly of claim 10, wherein the ceramic fibers comprise polycrystalline aluminosilicate fibers.

12. (canceled)

13. (canceled)

14. (canceled)

15. (canceled)

16. (canceled)

17. A method of sealing a surface of a fibrous web, the method comprising:
applying onto the surface a mixture comprising a fluoropolymer emulsion and alkali silicate dispersed in water; and
removing the water from the mixture to cure the alkali silicate and seal the surface.

18. The method of claim 17, wherein the water is removed by heating the mixture to a temperature of above 140° C.

19. The method of claim 17, wherein the fibrous web comprises oxidized polyacrylonitrile.

20. The method of claim 17, wherein the fibrous web comprises ceramic fibers.

21. The method of claim 20, wherein the ceramic fibers comprise polycrystalline aluminosilicate fibers.
